(19) United States
(12) Patent Application Publication
(10) Pub. No.: US 2005/0189004 A1
(43) Pub. Date: Sep. 1, 2005

(54) Cleaning device and container for a shaving apparatus

(76) Inventors: Jurgen Hoser, Neu-Anspach (DE); Diana Kappes, Eppstein (DE); Andreas Larscheid, Kelkheim-Fischbach (DE); Uwe Ludascher, Frankfurt (DE); Michael Petrettty, Oberursel (DE); Michael Franke, darmstadt (DE); Svatopluk Krumnikl, Kronberg (DE)

Correspondence Address: FISH & RICHARDSON PC, 225 FRANKLIN ST, BOSTON, MA, 02110, US

(21) Appl. No.: 11/085,424

(22) Filed: Mar. 21, 2005

Related U.S. Application Data
(63) Continuation of application No. PCT/EP03/08798, filed on Aug. 8, 2003.

(30) Foreign Application Priority Data
Sep. 21, 2002 (DE) 102 44 050.6

(51) Int. Cl. B08B 3/04

(52) U.S. Cl. 134/111; 134/166 R; 134/169 R; 134/113; 134/135; 134/186

(57) ABSTRACT

A cleaning device for the shaving head of a shaving apparatus includes a housing, a receptacle for receiving the shaving head and a container for cleaning fluid that is supplied to the shaving head wherein the housing in the region of at least one of the side walls of the container is provided with at least one window for monitoring the level of fluid in the container. The sides walls can be constructed from a transparent material and the container base can be formed from a comparatively less transparent material.

### CROSS-REFERENCE TO RELATED APPLICATIONS

This is a continuation of PCT Application No. PCT/EP2003/008798, filed on Aug. 8, 2003, which claims priority to German Patent Application No. 102 44 050.6, filed on Sep. 21, 2002, which is incorporated herein by reference in its entirety.

### TECHNICAL FIELD

This description relates to a cleaning device for the shaving head of a shaving apparatus, particularly an electric shaving apparatus.

### BACKGROUND

Cleaning devices can be used to clean shaving heads of dry shaving apparatus. In one such device, the dry shaving apparatus is inserted into a receptacle with its shaving head pointing down, and the receptacle is then filled several times with cleaning fluid. During the cleaning process the dry shaving apparatus is put into operation temporarily, the cleaning fluid dislodges hair residues and deposits adhering to the shaving head and transports them back to the cleaning fluid container from which the cleaning fluid was previously conveyed to the shaving head. During the cleaning process the dry shaving apparatus is electrically connected to the cleaning device. The actual cleaning process is then followed by a drying operation. Any fluid still adhering to the shaving head is evaporated in the process. Evaporation and contamination of the cleaning fluid during use may necessitate replacement of the container at regular intervals. Provision can be made for an electric fluid level indicator which uses a corresponding light signal on an indicating device that is attached to the housing of the cleaning apparatus to notify the user when the level of liquid in the container drops by a certain amount. To control the light signal provision liquid in the container drops by a certain amount. To control the light signal provision is made for electrodes which project into the container and are acted upon by the cleaning fluid until the level of the liquid drops by a certain amount. The light signal is then triggered when the electrodes are above the level of the fluid.

### SUMMARY

According to one aspect, a cleaning device for the shaving head of a shaving apparatus provides reliable monitoring of a level of fluid in a container by its user while incurring a minimum outlay in terms of cost and assembly effort.

In one embodiment, at least one window is provided for monitoring the level of fluid in the container in the housing in the region of at least one of the side walls of the container. The side walls are constructed from a transparent material and the container base from a comparatively less transparent material. Due to the colored container base the cleaning fluid appears in the color of the base and a sharp contrast is created at its surface. At the same time, the interior of the container is visible due to the transparency of the side wall.

In another embodiment, all of the side walls of the container and the upper boundary wall are constructed of a material having substantially the same transparency. All that is then required when assembling the container is to connect a trough-shaped part to the base.

The container can be releasably connected to the housing so that when the cleaning fluid requires replacement, it can be conveniently changed by replacing the old cartridge with a fresh one.

In another embodiment, to more clearly indicate the level of the cleaning fluid held in the container, an illuminating device, such as an LED for example, may be provided in the housing to intensifies the contrast between the filled and unfilled region of the container. The illuminated device permits an accurate reading of the level of fluid in the container in the cleaning device even in a bright outer environment. The illuminating device may be designed to emit either white or colored light. The illuminating device may be constructed such that it projects at least partly into the container, as the result of which the surface of the cleaning fluid is presented in high contrast to its surroundings. The illuminating device may be comprised of at least one LED.

Certain embodiments allow for ease of construction and multiple locations for the illuminating device. The illuminating device can include a light guide which extends from the illuminating device in the direction of or into the container. This allows the illuminating device to be implemented even under the most adverse conditions of installation and the free surface of the cleaning fluid in the container to be optimally illuminated.

Another embodiment provides for the illuminating device to project at least partly into the cleaning fluid. This configuration can provide for special optical effects to be achieved dependent on the depth of projection. Namely, various optical appearances and intensities of light present themselves, dependent on the level of fluid in the container relative to the light source, and can be used for reading the level of fluid. This presentation can be intensified by using colored light or colored or multi-colored light guides to change the colored presentation of the illuminated fluid when the level of fluid changes.

Further embodiments may include a container for the cleaning fluid in which the level of fluid presents itself clearly and in high contrast. This may be accomplished by constructing the side walls from a transparent material and the container base from a comparatively less transparent material. Due to the transparent side walls even a colorless fluid is clear to recognize. When a colored light is coupled into the fluid through the colored base, the contrast between the level of the fluid and the environment is intensified.

In this context, a preferred embodiment provides for the side walls as well as the upper boundary wall of the container to be transparent. The container advantageously contains an essentially colorless cleaning fluid.

Further objects, features, advantages and application possibilities of the present invention will become apparent from the subsequent description of the embodiments. It will be understood that any single feature or any combination of single features described or represented by illustration forms the subject-matter of the present invention, irrespective of their summary in the claims or their back-reference. dr

### DESCRIPTION OF DRAWINGS

FIG. 1 is an overall view of a one embodiment of the cleaning device;

FIG. 2 is a view of a cleaning fluid container; and

FIG. 3 is a sectional view of a container into which the cleaning device is inserted.

Like reference symbols in the various drawings indicate like elements.

### DETAILED DESCRIPTION

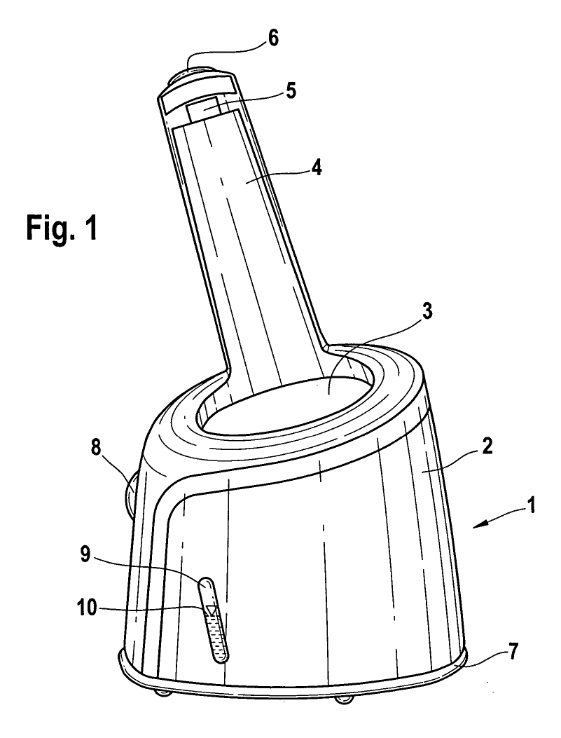

The cleaning device 1 illustrated in FIG. 1 has a housing 2 in which a trough-shaped receptacle 3 is provided for the shaving head of a shaving apparatus. (For the sake of clarity, the shaving apparatus is not shown in the drawing). The cleaning process begins by inserting the shaving head of the shaver into the receptacle. Next, cleaning fluid is supplied to the receptacle such that the shaving parts of the shaving head are immersed in the supplied cleaning fluid which is directed through suitable return lines back to the container with the cleaning fluid. The electric shaving apparatus is also set in operation during the cleaning process, and for this purpose it is electrically connected to the cleaning device 1 which is connected to the electric power supply. For this purpose the housing 2 has a holding arm 4, on whose free end provision is made for electric contacts 5 which make or break an electric connection to the shaving apparatus when the actuating button 6 is depressed accordingly.

The housing 2 is vertically slidably mounted on a base plate 7 so that the container for cleaning fluid can be inserted in the housing from the side. An unlocking button 8 is provided to disengage the base plate 7 from the housing 2.

The housing 2 is equipped with a transparent window 9 to allow a user to monitor the level of the cleaning fluid in the container and the container to be replaced the fluid if necessary. The fluid level 10 can be clearly read through this window 9 because the side walls of the container at least in the region of the window 9 are constructed to be transparent while the container base is far less transparent in comparison. In some embodiments the container base may be blue.

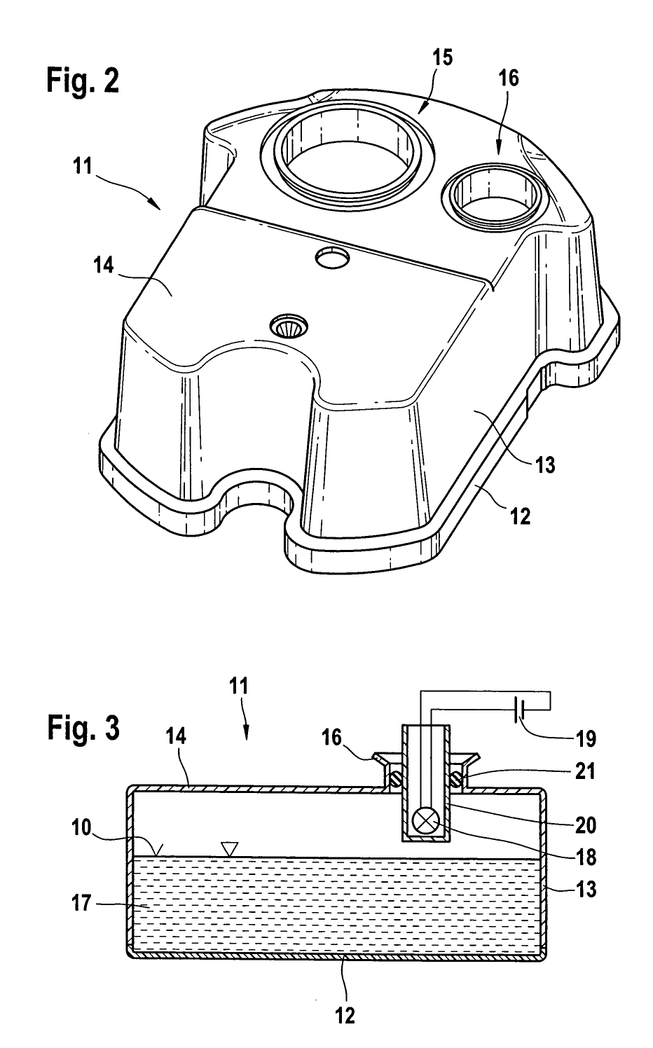

Such a container is illustrated in detail in FIGS. 2 and 3. According to FIG. 2, the container 11 includes a container base 12, a circumferential side wall 13 and an upper boundary wall 14. The side wall 13 and the upper boundary wall 14 are constructed in one integral piece as a trough-shaped component from transparent material. By contrast, the container base 12 is colored with a dye and is welded along its edge to the circumferential side wall 13 so as to form a closed container. When this container 11 is filled with colorless cleaning fluid, the fluid appears to the observer as the substantially the same color as that of the container base. For example, if the container base 12 is blue the colorless cleaning liquid will appear substantially blue as well. The current level of fluid in the container is well visible from the outside through the transparent side walls 13 and contrasts clearly and in color with its surroundings.

The container 11 is equipped in the region of the upper boundary wall 14 with an outlet port 15 and a return port 16. A pump device, which pumps the cleaning fluid from the container 11 into the receptacle 3, projects into the outlet port 15 after the container 11 is inserted into the housing 2 of the cleaning device 1. From the receptacle the fluid then flows through the return port 16 back into the container 11. While circulating, the cleaning fluid passes through at least one filter device, not shown in the drawing, which collects hair dust and other contaminants.

To clearly indicate the level 10 of cleaning fluid 17 when the container 11 is arranged in the housing 2, an embodiment illustrated in FIG. 3 provides for an illuminating device to be integrated in the cleaning device 1. FIG. 3 presents a section through the container 11 which passes through the return port 16. In this case the illuminating device is constructed as an LED 18 which is arranged in the housing 2 such that it projects down into the container 11 after the container 11 with cleaning fluid 17 is locked in place by lowering of the housing 2. As soon as the cleaning device 1 is set in operation, the LED is connected to a voltage source 19 so that the surface of the cleaning fluid 17 is illuminated. Thus, the fluid level 10 can be clearly read and in high contrast through the window 9 of the housing 2. The cleaning fluid 17 is colorless but because of the coloring of the housing base 12 it appears in its color. The LED 18 is enclosed in a capsule 20 which extends through the return port 16. It will be understood, of course, that the capsule 20 takes up just a part of the area of cross-section of the return port 16 so that the return flow of cleaning fluid into the container 11 is still guaranteed. The capsule 20 is sealed against the container 11 by a sealing ring 21. The capsule 20 may also be constructed as one integral piece with a return pipe. As a result of the encapsulation of the LED 18 it is also possible to have the illuminating device project into the cleaning fluid 17 below the fluid level 10, thus producing special optical effects dependent on the level of the fluid. This applies in particular when the capsule itself is variously colored.

Instead of protecting the LED 18 from the cleaning fluid 17 with a capsule 20, it is also possible to use a light guide which directs the light from the LED arranged outside the container 11 through an opening in the container 11 and into the latter.

Other embodiments are within the claims.

1. A cleaning device for a shaving head of a shaving apparatus comprising:
a housing;
a receptacle formed in said housing for receiving said shaving head;
a container connected to said housing for supplying a cleaning fluid to said shaving head, said container having at least one side wall and a container base, said container constructed from a first material; and
a window in at least one of said side walls to monitor the level of said cleaning fluid in said container, said window constructed from a second material;
wherein said second material is more transparent than said first material.

2. The cleaning device of claim 1 further comprising an upper boundary wall welded to said base, said upper boundary wall constructed from a third material, said third material having substantially the same transparency first material.

3. The cleaning device of claim 1 wherein said container is releasably connected to said housing.

4. The cleaning device of claim 1 further comprising an illuminating device within said housing.

6. The cleaning device of claim 4 wherein said illuminating device projects at least partly into said container.

7. The cleaning device of claim 4 wherein said illuminating device is comprised of at least one LED.

8. The c cleaning device of claim 4 wherein said illuminating device has a light guide.

9. The cleaning device of claim 4 wherein said illuminating device projects at least partly into said cleaning fluid.

10. The cleaning device of claim 9 wherein said container base is constructed from a material having a first color.

11. The cleaning device of claim 10 wherein said illuminating device causes said cleaning fluid to substantially appear the same color as said container base.

11. The container of claim 10 wherein said first color is blue.

12. A container for cleaning fluid for a cleaning device for a shaving head of a shaving apparatus comprising:
at least one container base constructed from a first material; and
side walls connected to said at least one container base, said side walls constructed from a second material;
wherein said first material is more transparent than said second material.

13. The container of claim 12 further comprising an upper boundary wall that is constructed from a third material, said third material being substantially transparent.

14. The container of claim 12 wherein said cleaning fluid is substantially colorless.

15. The container of claim 12 wherein said container base is blue.

16. A cleaning device for a shaving head of a shaving apparatus comprising:
a housing;
a receptacle formed in said housing for receiving said shaving head;
a container connected to said housing for supplying a cleaning fluid to said shaving head, said container having at least one side wall and a container base, said container constructed from a first material; and
a window in at least one of said side walls to monitor the level of said cleaning fluid in said container, said window constructed from a second material;
an upper boundary wall constructed from a third material, said third material having substantially the same transparency first material;
an illuminating device within said housing;
wherein said second material is more transparent than said first material.
